(19) United States
(12) Patent Application Publication
(10) Pub. No.: US 2012/0091377 A1
(43) Pub. Date: Apr. 19, 2012

(54) Conservation Device for Use With a Showerhead

(75) Inventor: Daniel Tips, Plano, TX (US)

(73) Assignee: 11:11:7, LLC, Plano, TX (US)

(21) Appl. No.: 13/277,790

(22) Filed: Oct. 20, 2011

Related U.S. Application Data
(63) Continuation-in-part of application No. 12/425,783, filed on Apr. 17, 2009.

(51) Int. Cl. F16K 31/44

(52) U.S. Cl. 251/231

(57) ABSTRACT

A water conservation device for use with a showerhead includes a body portion including an inlet and a reduced flow outlet. A valve element is disposed within the body portion. It includes a port and is pivotable within the body portion between an open position and a closed position. A pivot axle connects to the valve element and extends from the inner surface of the body to the outer surface. A lever includes a first distal end portion and a first proximal end portion. The first distal end portion rigidly connects to and extends from the axle. A rigid handle has a second distal end portion and a second proximal end portion. The second distal end portion of the handle is pivotably connected to the first proximal end portion of the lever.

### TECHNICAL FIELD

This application is a continuation-in part-application of U.S. patent application Ser. No. 12/425,783, filed Apr. 17, 2009, incorporated herein by reference.

### TECHNICAL FIELD

This disclosure relates in general to a conservation device, and more particularly, this disclosure relates to a water, sewer, and electric or gas conservation device for use with a showerhead.

### BACKGROUND

A great many gallons of water are wasted daily by running showers while performing hygiene or other tasks in the shower, such as shaving, by running showers while people prepare to enter the shower, by simply not providing an easy way to control shower flow, among other reasons. At least in part because of this wasted water, fresh water resources in many areas are being stressed by growing demands due to increasing population.

The present disclosure overcomes one or more shortcomings in the art.

### SUMMARY

The present disclosure teaches a device that permits a user to control water flow with a reduced flow outlet that restricts fluid communication between the outlet and the shower head. This reduced flow outlet, in one embodiment, is a restrictor plate formed and configured to reduce the fluid flow rate from, but not limited to, about six gallons per minute (gpm) to a specified flow rate such as, but not limited to, about 2 gpm or 1.5 gpm. This creates a particular advantage over other valves that do not reduce the water flow rate because it mandates conservation. Further conservation is obtained using a rigid hanging handle that can be easily found, grasped, and used in the shower. While not obvious, in some embodiments, the rigid hanging handle is configured to be handicap accessible. That is, some embodiments of the rigid handle are designed with a shape that allows the handle to be actuated, such as raised or lowered, using only a nub of a limb. Accordingly, in these embodiments, the handle can be actuated without being grasped or gripped by a user's hand. The handle freely hangs vertically down from the showerhead, and a user can vertically raise or lower the handle to increase or decrease water flow. In order to conserve water, conscientious users may desire to turn off the water during time consuming hygiene steps such as shaving, and then turn the water back on prior to completing the shower. Others may only decrease the flow, while leaving a flow that still provides a level of warm or cool water for comfort. The device may find particular utility where hot water supply is limited, and a user desires to conserve the hot water to avoid a cold shower. Because the user can control the amount of pressure at the nozzle so that force and usage amounts are controllable, while still having a desired flow for washing.

The handle size, hanging from adjacent a water source pipe, permits users to easily locate and operate the handle to increase or decrease flow, even without visually looking. Accordingly, if shampoo or soap is in a user's eyes, he or she can still easily find the handle to increase water flow for rinsing.

Because of the handle's length and location, small children can reach the handle to control the device. Accordingly, an adult may set the water temperature using the taps, and then decrease or stop the water flow using the disclosed device while the child prepares for the shower. When ready, the child can start the water flow independent of the taps that might change the water temperature, conserving water while reducing the chance of water that is too hot. The device is also useful for elderly who may no longer have the ability to reach a showerhead. When starting a shower, hot water is typically turned on first wasting a large amount of water waiting for the hot water to arrive, and then the cold water is applied trying to set a desired temperature. After obtaining a desired temperature, users simply turn off the valve by pulling down on the handle, stopping the water flow and by leaving the taps in a pre set orientation making it possible for the user to simply lift up on the handle and enjoy the pre set temperatures for their next shower without wasting water and time trying to re set the desired temperature.

Further, because the device permits users to control or regulate the amount flow in a range between no flow and full flow, the user can limit flow during periods of showering or preparing to enter the shower while not turning the water off. A particular advantage in this design is the reduced flow restrictor plate which has several functions. For example, it restricts fluid communication between the outlet and the shower head, and the oval or slot-like opening helps maintain gallons per minute (gpm) of the fluid communication to the shower head as the pressure fluctuates so this helps maintain pressure, for example, approximately 2.0 gpm at 80 pounds per square inch (psi) as well as approximately 2.0 gpm at 30 psi. With a typical round opening the gpm of the fluid communication would reduce as the psi pressure reduces. A small level of water flow keeps pipes warm, reducing cooling that may otherwise occur in the pipe when flow is off. For example, a user may reduce flow while shaving or soaping instead of turning flow off so that when flow is increased later, the hot water in the pipes has not appreciably cooled, thereby substantially maintaining the desired temperature.

The device provides additional advantages to handicap users who cannot otherwise control flow through a showerhead without operating the taps and potentially changing water temperature. The long handle is configured to be handicap accessible, whereas it can be operated with a nub of a limb, and does not require being grasped by a hand. In another example, a user can control flow independent of the taps while sitting on a chair or stool in the shower. Where the handicap person must be washed by attendants, the simple operation and convenient location of the handle further simplifies water control and conservation, permitting an attendant to assist while also controlling flow in order to most conveniently meet the flow demands during the particular stages of the shower, such as providing a higher flow for rinsing and a lower flow during soaping.

The device can be installed between a water source pipe and a showerhead. Some embodiments of the device include an integral showerhead, while other embodiments are separate from the showerhead, but may be packaged or sold with a showerhead. Yet other embodiments are sold independent of a showerhead.

Because of its location relative to the showerhead, the device can be used to turn off water flow to a showerhead during head replacement, when showerheads leak until the problem can be located and repaired, or during other time periods.

Due to it nature, the reduced flow device can be used to directly reduce water consumption and it also can be used to conserve gas or electricity not used to heat water that was being wasted and to conserve sewer resources by reducing the amounts of water requiring treatment. By controlling the water flow, users can choose to consume less hot water, decreasing gas or electric consumption. Likewise, by reducing water flow, less water goes to the sewer. This can result in lower utility bills and fewer out-of-pocket expenses for consumers.

In some aspects, the present disclosure is directed to a water, sewer, and gas or electric conservation device for use with a showerhead. The device comprises a body portion including an inlet, an reduced flow outlet, an inner surface, and an outer surface. The outer surface adjacent the reduced flow outlet is threaded and configured to mate with an additional shower component. The inner surface adjacent the inlet is threaded for mating with a water source pipe. A valve element is disposed within the body portion. It includes a port and is pivotable within the body portion between an open position and a closed position. The open position places the inlet and outlet in fluid communication through the valve element and the closed position restricts fluid communication between the inlet and outlet. A pivot axle connects to the valve element and extends from the inner surface of the body to the outer surface. A reduced flow outlet restricts fluid communication between the outlet and the shower head. This reduced flow outlet is preferred over a reduced flow inlet because it allows for easy cleaning by simply removing the shower head then cleaning the outlet, flushing by turning on the water, then reinstalling the shower head. It would take many more steps to clean a reduced flow inlet without the chance of clogging a showerhead. This reduced flow outlet can be manufactured to reduce the flow rate from, but not limited to, about six gallons per minute (gpm) to a specified flow rate such as, but not limited to, about 2 gpm or about 1.5 gpm. This creates a particular advantage over other valves that do not reduce the water flow rate because this mandates conservation. Using the handle connected to the lever gives another particular advantage of not only furthering conservation but also allowing handicapped people to actuate the valve and allowing short people the ability to use the valve that could normally not be reached. A lever includes a first distal end portion and a first proximal end portion. The first distal end portion rigidly connects to and extends from the axle. A rigid handle has a second distal end portion and a second proximal end portion. The second distal end portion of the handle is pivotably connected to the first proximal end portion of the lever.

In yet other aspects, the present disclosure is directed to a water, sewer, and gas or electric conservation system. It includes a body portion including an inlet, a reduced flow outlet, an inner surface, and an outer surface. The inlet is configured to mate with a separate plumbing fixture. The reduced flow outlet is configured to mate with a showerhead as well as reduce the flow of water to a pre-determined flow rate available to a shower head. A valve element is disposed within the body portion and includes a port and is pivotable within the body portion between an open position and a closed position. The open position provides fluid communication through the body portion and the closed position restricts fluid communication through the body portion. A pivot axle integrally connects to the valve element and extends from the inner surface of the body portion to the outer surface. A lever comprises a first distal end portion and a first proximal end portion. The lever rigidly connects to and extends from the axle. A pivot stop is configured to limit the range of rotation of the pivot axle. The range of rotation is limited to about 90 degrees or less. A rigid handle has a second distal end portion and a second proximal end portion. The second distal end portion of the handle is pivotably connected to the first proximal end portion of the lever by a connector. The connector permits the handle to freely pivot relative to the lever so that the handle freely hangs vertically downward from the connector.

In yet other aspects, this disclosure is directed to a water, sewer, and gas or electric conservation system that includes a body portion including an inlet, a reduced flow outlet, an inner surface, and an outer surface. The inlet is configured to mate with a separate plumbing fixture. The reduced flow outlet is configured to mate with a showerhead as well as reduce the flow of water to a pre-determined flow rate available to a shower head. A ball valve element is disposed within the body portion. It includes a port pivotable within the body portion between an open position and a closed position. The open position provides fluid communication through the body portion and the closed position restricts fluid communication through the body portion and any position in-between A pivot axle connects to the valve element and extends from the inner surface of the body to the outer surface. A lever has a first distal end portion and a first proximal end portion. The lever rigidly connects to and extends from the axle. A pivot stop is located on the body portion to limit a range of rotation of the pivot axle by mechanically blocking movement of the lever beyond the range of rotation. The range of rotation is limited to about 90 degrees or less. A rigid handle has a second distal end portion and a second proximal end portion. The second distal end portion of the handle is pivotably connected to the first proximal end portion of the lever by a connector. The connector permits the handle to freely pivot relative to the lever so that the handle freely hangs vertically downward from the connector, the handle having total length within the range of about 6 and 48 inches for grasping by a user.

Further aspects, forms, embodiments, objects, features, benefits, and advantages of the present invention shall become apparent from the detailed drawings and descriptions provided herein.

### BRIEF DESCRIPTION OF THE DRAWINGS

FIG. 1 is an illustration of an exemplary water conservation system according to a first aspect of the invention including a water conservation device.

FIG. 2 is an illustration of the water conservation device of FIG. 1.

FIG. 3 is an illustration of a body portion of the water conservation device of FIG. 1 with a lever and handle removed.

FIG. 4 is an illustration of a cross-sectional view of the body portion of the water conservation device of FIG. 3.

FIG. 4A is an end view of a flow restrictor plate in accordance with one aspect of the present disclosure.

FIG. 5 is an illustration of a gauge and detent usable on the body portion of FIG. 3.

FIGS. 6-8 are illustrations of exemplary levers and handles of the water conservation device of FIG. 1.

FIG. 9 is an illustration of an exemplary embodiment using surface features or indentations as reference markings.

FIG. 10 is an illustration of an exemplary axle with a surface feature or indentation as a reference marking.

### DETAILED DESCRIPTION

For the purposes of promoting an understanding of the principles of the invention, reference will now be made to the embodiments, or examples, illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

The present disclosure is directed to a water conservation system for a shower head that permits a user to easily control the flow of water through the valve while showering, while helping to maintain temperature when turned down to a trickle. The system includes a conservation device that includes an easily grasped rigid handle or a handicap accessible rigid portion allowing the device to be operated with a nub of a limb, both of which are movable vertically upward or downward to increase or decrease the flow of water through the device. The handle hangs downward from the water source pipe, allowing a user to easily locate it without looking. Further, it may be used by children or others who have traditionally been unable to reach the shower head. Some embodiments double as a shower caddy or organization system, permitting a user to store hygiene items sometimes used in a shower, such as razors, tooth brushes, bath sponges, mitts, minors, and other items.

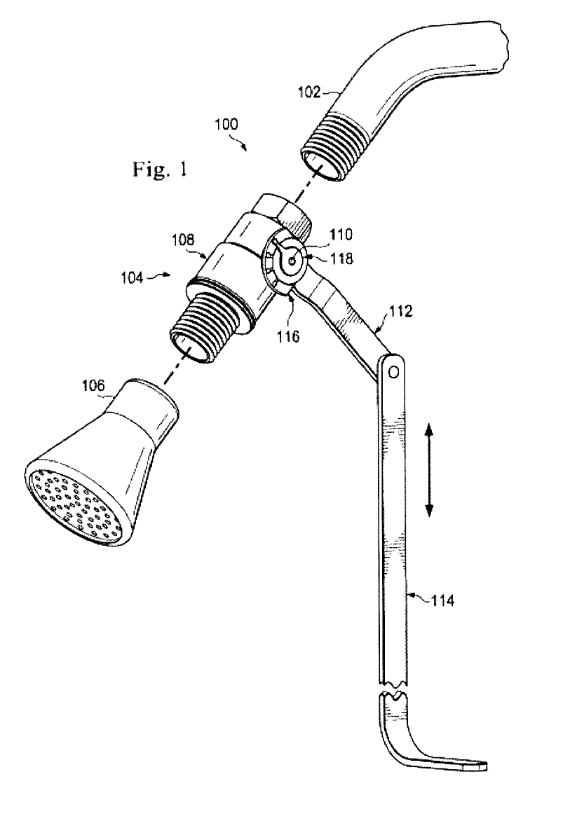

FIG. 1 shows an exemplary embodiment of the shower system 100. The shower system 100 includes a water source pipe 102 extending from a wall, a reduced flow water conservation device 104, and a shower head or sprayer nozzle 106. Using a valve element, the reduced flow water conservation device 104 regulates the flow of water and permits a user to turn water through the device on, off, or “anywhere in between” as desired. While not obvious, the opening 137 incorporated in the reduced flow restrictor plate 135 affords a particular advantage over a round hole found in other valves because it allows substantially more regulation of the flow of water as the axle turns within the approximate 90 rotation range or the “anywhere in-between” range. For example, it may help maintain gallons per minute (gpm) of the fluid communication to the shower head as the pressure fluctuates so this helps maintain pressure, for example, approximately 2.0 gpm at 80 pounds per square inch (psi) as well as approximately 2.0 gpm at 30 psi. With a typical round opening the gpm of the fluid communication would reduce as the psi pressure reduces.

Still referring to FIG. 1, the device 104 includes a body 108, a pivot axle 110, a lever 112, and a handle 114. Some device embodiments, including the embodiment in FIG. 1, include an optional gauge 116 and optional needle 118 that permit a user to visually identify how much the device is opened, enabling a user to better regulate flow through the device. In this embodiment, the needle is aligned with the lever 112. However, in other embodiments, the needle is not included and the lever may be used with the gauge to identify the relative position. Other embodiments include neither the gauge nor the needle. In the example shown in FIG. 1, as indicated by the needle and the lever, the device is in a closed position, fully restricting water flow through the device. It should be recognized that some embodiments do not permit a user to fully close the device, but only substantially close the device or reduce flow from a fully open or substantially open position.

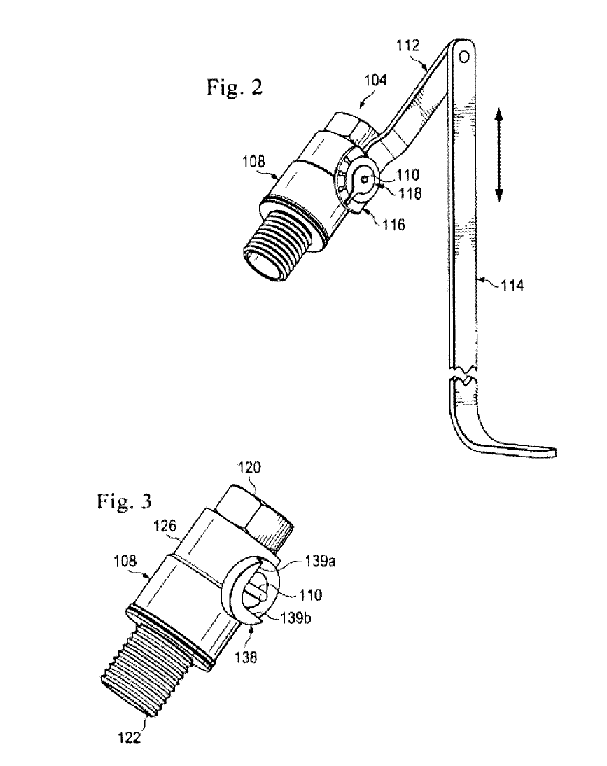

FIG. 2 shows the device 104 with the lever 112 in a fully open or substantially open position. This is done by raising the handle 114 vertically to displace the lever 112 and create a moment that pivots the pivot axle 110, opening the device 104. It should be noted that the device 104 may be opened to any degree between the fully open or fully closed positions, depending upon user's preference.

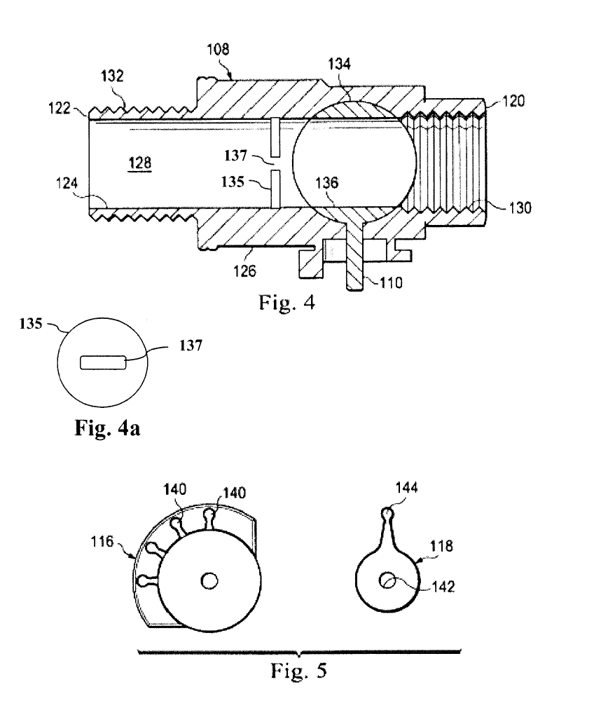

FIGS. 3 and 4 show the body 108 with the lever 112 and handle 114 removed. The body 108 includes a distal end 120, a proximal end 122, an inner surface 124, a reduced flow restrictor plate 135, other embodiments may include a round opening 137 while this embodiment incorporates an oval or oblong opening 137 in the reduced flow restrictor plate 135 pre-setting a reduced flow rate, within the range of about 1 to 3 gpm. Some embodiments are limited to, for example, about 2.0 gpm or about 1.5 gpm, and an outer surface 126. The opening 137 incorporated in the reduced flow restrictor plate 135 affords a particular advantage over a round hole found in other valves because it allows substantially more regulation of the flow of water as the axle turns within the approximate 90 rotation range. The reduced flow restrictor plate may operate to restrict fluid communication between the outlet and the shower head, and the opening may help maintain gallons per minute (gpm) of the fluid communication to the shower head as the pressure fluctuates. For example, this helps maintain flow even at different pressures. For example, an oval opening may help maintain approximately 2.0 gpm at 80 pounds per square inch (psi) as well as approximately 2.0 gpm at 30 psi. With a typical round opening the gpm of the fluid communication would reduce as the pressure (psi) reduces. The inner surface 122 forms a through passage 128. At the distal end 120, the body 108 includes inner threads 130 for attaching to additional plumbing, such as the water source pipe 102 in FIG. 1 Likewise, outer threads 132 on the outer surface 126 permit attachment to additional plumbing such as the shower head 106 in FIG. 1.

Within the body 108, a valve element 134 permits a user to open and close the device 104. In this embodiment, the valve element 134 is a ball valve connected to the pivot axis 110. In some embodiments, the valve element 134 and the pivot axis 110 are integral. Rotation of the pivot axis 110 about its axis turns the valve element 134 between an open position, where a port 136 of the valve element 134 aligns at least partially with the passage 128, and a closed position, where the port 136 is not aligned with, or is transverse to the passage 128, thereby blocking, reducing, or preventing water flow.

FIG. 3 shows a pivot stop 138 on the outer surface 126 of the body 108. The pivot stop directly or indirectly limits the pivot range of the pivot axle 110, as shown in FIGS. 1 and 2. In the exemplary embodiment shown, the pivot stop 138 cooperates with sides of the lever 112 to limit the range that the lever 112 can travel, thereby effectively limiting the pivot range of the pivot axle 110, connected to and rotatable with the lever 112. The pivot stop 138 includes two contact stop surfaces 139a, 139b that cooperate with and contact opposing sides of the lever 112. These contact stop surfaces 139a, 139b prevent the lever from passing beyond the set range of pivot motion, which in the embodiment shown, is 90 degrees.

FIG. 5 shows the optional gauge 116 and needle 118 usable with the device 104. In some embodiments, the gauge 116 is formed on the body 108, while in other embodiments, it may be fixed to the body 108, such as by being disposed over the pivot axle 110 so that it is located as shown in FIG. 1. The gauge 116 may include a series of indentations, as identified by the reference numeral 140, marking a range of motion. For example, where the range of motion of the valve element 134 (FIG. 4) of the device 104 is limited to 90 degrees, as is the device in FIG. 1, the indentations 140 may be located at about 23 degrees, 45 degrees, and 68 degrees, for example. The indentations 140 may be lines as shown, or may be divots or be otherwise shaped. Some embodiments include numerical or other printed or formed indicia adjacent the indentations that visually identify how much the valve element is open. For example, the indicia may identify ¼, ½, and ¾ of the way open. Additional indentations or indicia may be provided. In some embodiment, the lines or indicia are not indented, but are otherwise marked or formed on the gauge 116. The example gauge shown includes an aperture 142 that may be placed over the pivot axle 110 to secure the gauge in place relative to the axle 110. In other embodiments, the gauge 116 is a sticker applied by an adhesive, stamped or machined onto the body 108, or otherwise formed.

The optional needle 118 may be attached to the pivot axle 110 to identify the position of the pivot axle 110, and thus also the valve element 134, relative to the body 108. Accordingly, in the embodiment shown, the needle 118 includes an aperture 142 that receives and connects with the pivot axle 110. As such, the needle 118 is fixed to and moves with the pivot axle 110 to move relative to the gauge 116 and visually indicate to a user how far the device 104 is open or closed. In some embodiments, the needle 118 includes a protrusion such as a detent 144 that cooperates with the indentations 140 on the gauge. Accordingly, in this embodiment, as a user moves the pivot axle 110, the needle 118 pivots relative to the gauge and the detent 144 enters and exits the indentations 140, providing a user with tactile feedback through the handle 114 about how much the device is open or closed. In some embodiments, the detent 144 makes an audible click when it enters the indentations 140, again providing the user with feedback about how much the device is open or closed. In some embodiments, the needle 118 does not physically contact the gauge 116, but moves relative to it to provide only a visual indicator.

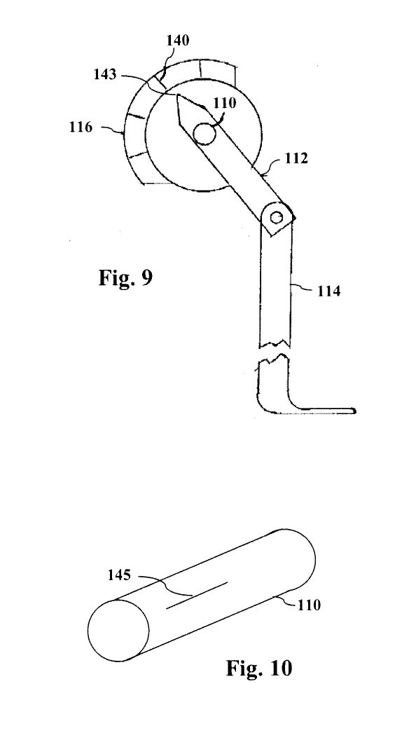

FIG. 9 shows an embodiment where the lever 112 includes a distal pointed end acting as a reference needle 143. The pointed end pivots with the pivot axle to move relative to the gauge. The description above relating to the needle 118 is applicable to the reference needle 143.

FIG. 10 shows an axle 110 with an indentation, reference marker, or printed or marked reference line 145 formed thereon instead of a needle 118. The reference line 145 may indicate a relative position relative to the indentations or other reference marks 140 in FIG. 9 or the lines 140 in FIG. 5, as discussed above.

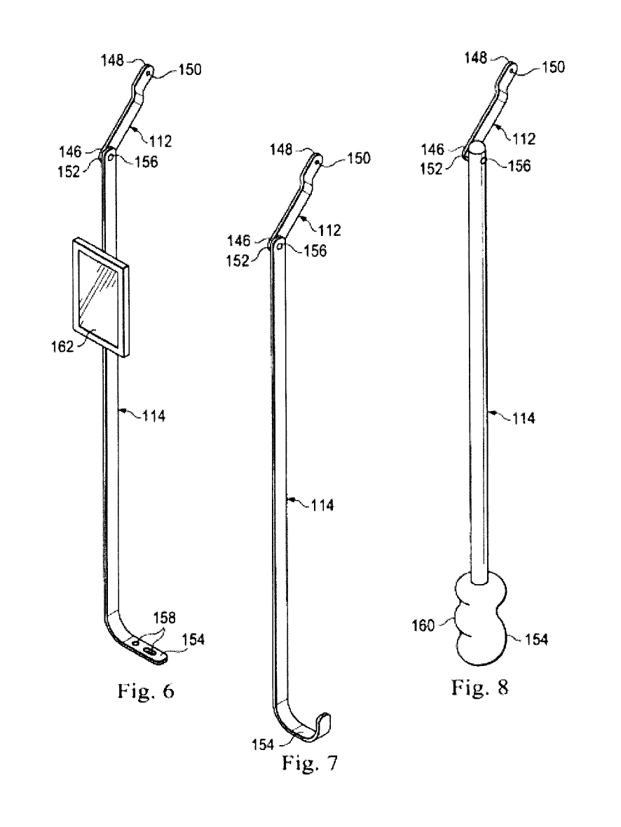

Exemplary levers 112 and handles 114 are shown in and more particularly described with reference to FIGS. 6-8. Referring first to FIG. 6, the lever 112 is a rigid, elongated plate that includes a proximal end 146 and a distal end 148. The distal end 148 is configured to attach to the pivot axle 110 in a manner that the lever 112 can apply torque to rotate the pivot axle about its longitudinal axis. In so doing, the lever 112 rotates the valve element 134 (FIG. 4) to open and close the device 104. In the embodiment shown, the distal end 148 includes an aperture 150 that receives the pivot axle 110. In some embodiments, the pivot axle 110 and the aperture 150 are splined in order to transmit torque from the lever 112. In other embodiments, the pivot axle 110 and the aperture 150 are secured by the use of a nut tightened onto pivot axle threads. Other methods and systems for connecting the lever and pivot axle are contemplated. The proximal end 146 is configured to attach to the handle 114. In the example shown, the sides of the lever 112 are configured to contact and interface with the contact stop surfaces 139a, 139b of the pivot stop 138 (FIG. 3). This limits the pivot range of the lever 112, and thus the pivot range of the valve element 134. In the embodiment shown, the pivot range is 90 degrees. In other examples however, the pivot range is greater or less than 90 degrees.

Although shown as a plate, it should be apparent that the lever 112 may also be a bar, beam or other rigid structure. The shape of the lever, as well as the handle described below, may be selected for its aesthetics to render the device 104 both elegant and stylish. For example, in some embodiments, the lever is a round bar formed of brass or polished steel. In other embodiments, it is formed of a polymer or a composite. Other materials and styles also are contemplated.

The handle 114 is an elongated rigid structure that like the lever 112, may be formed as a plate, bar, beam, or other rigid structure. It includes a distal end 152 and a proximal end 154. The distal end 152 is configured to connect to the proximal end 146 of the lever 112. Here, the connection is by a pivot pin 156 extending through and connecting both the lever 112 and the handle 114. Here, the connection is not rigid, but permits the lever and the handle to move relative to each other. Accordingly, in the example shown, the handle 114 freely hangs from the proximal end 146 of the lever 112. Accordingly, regardless of the position of the lever 112, the handle 114 is in a substantially vertical position. In some embodiments, the connection is a hinge, a rivet, or other known connectors. In some embodiments, the connector is integral with the one of the lever and the handle. In some of these embodiments, the two can be snap-fitted together.

The handle 114 has length much greater than the length of the lever 112, and in some embodiments is in the range between 6 and 48 inches. This length range accommodates most showers and allows a user to select a style and length that accommodates the user's needs. For example, a longer handle 114 may be desired in a shower used by children, while a shorter handle may be desired in a shower used by grown adults. Some additional handle embodiments have a length between about 12 and 36 inches, while some have a length between about 12 and 24 inches, and others have a length between about 15 and 18 inches. Lengths both longer and shorter than these ranges also are contemplated.

The handle 114 is configured to be grasped by a user for controlling the device 104. The handle 114 is also configured to be handicap accessible, such that it can be operated by a nub. To make it handicap accessible, it includes rigid surface portions that extend in a substantially horizontal direction that may be both pushed upward by a user's limb, but also may be pushed downward by a user's limb. In some examples, the horizontal surface portions are a portion of a ring or other curved surface that may be actuated by a user's limb without grasping the handle with a hand. As it applies loading to the lever 112 in both compression and tension, the handle is formed of a rigid material, and may be formed of the same materials and have the same general style as the lever 112.

In FIG. 6, the proximal end 154 of the handle 114 doubles as a shower caddy or hanging organizer accommodating items sometimes used in a shower. For example, the proximal end 154 bends to have a substantially horizontal portion that includes cut-out features 158 sized to receive, for example, a razor, a toothbrush, or other items used in a shower. Although shown as apertures centered in the handle, the cut-outs may be indentations in the handle side for laterally receiving a toothbrush or other items. In some embodiments, the horizontal region of the handle 114 has a region of increased width to form a soap dish. The horizontal nature may also be used for hanging or supporting other bath and shower accessories. Other shapes also are contemplated.

In addition to placing items along the exemplary horizontal portion of the handle 114, the vertical portion also may used for shower accessory items. In the example shown, an optional shaving minor is attached to the handle 114. The minor 162 may be attached by a mirror clip or alternatively, the handle 114 may include one or more clips, hooks, or other attachment systems for attaching shower items.

FIG. 7 shows another embodiment of a handle 114 shaped as a hook from which a bath mitt, body sponge, or body brush may be hung. It too is configured to be operated by a nub of a limb. FIG. 8 shows another embodiment of a handle 114. Here, the handle 114 is a cylindrical rod and includes a hand grip 160 that permits easy grasping by a user. Other handle embodiments also are contemplated, and these are shown merely as examples.

Applicant notes that the use of directional terms herein, such as upper, lower, lateral, proximal, and distal and others are merely exemplary, and may encompass other directions, unless so indicated. Although several embodiments have been illustrated and/or described, it will be understood that they are exemplary, and that a variety of substitutions and alterations are possible without departing from the spirit and scope of the present invention, as defined by the following claims.

I claim:

1. A water, sewer, and gas or electric conservation device for use with a showerhead, the device comprising:
a body portion including an inlet, a reduced flow outlet, an inner surface, and an outer surface, the outer surface adjacent the outlet being threaded and configured to mate with an additional shower component, the inner surface adjacent the inlet being threaded for mating with a water source pipe;
a valve element disposed within the body portion, the valve element including a port and being pivotable within the body portion between an open position and a closed position, the open position placing the inlet and outlet in fluid communication through the valve element and the closed position restricting fluid communication between the inlet and outlet;
a pivot axle connected to the valve element and extending from the inner surface of the body to the outer surface;
a lever having a first distal end portion and a first proximal end portion, the first distal end portion rigidly connected to and extending from the axle; and
a rigid handle having a second distal end portion and a second proximal end portion, the second distal end portion of the handle being pivotably connected to the first proximal end portion of the lever.

2. The conservation device of claim 1, wherein the second distal end portion of the handle is pivotably connected to the first proximal end portion of the lever by a connector that permits the handle to freely pivot relative to the lever so that the handle freely hangs vertically downward from the connector.

3. The conservation device of claim 1, wherein the handle comprises a grip disposed at the second proximal end portion.

4. The conservation device of claim 3, wherein the grip includes at least one feature forming a hanging shower organizer.

5. The conservation device of claim 4, wherein the at least one feature is a cut-out sized to fit and hold at least one of a toothbrush and a razor.

6. The conservation device of claim 5, wherein the grip is shaped so as to be handicap accessible for actuation with a nub of a limb.

7. The conservation device of claim 1, wherein the body comprises a first pivot stop surface and a second pivot stop surface, the first pivot stop surface limiting rotation of the axle in a first direction and the second pivot stop surface limiting rotation of the axle in a second direction.

8. The conservation device of claim 7, wherein the first and second pivot stop surfaces limit the range of rotation of the axle to about 90 degrees.

9. The conservation device of claim 1, further comprising a gauge associated with the body portion, the gauge being configured to indicate how much the valve element is open or closed.

10. The conservation device of claim 9, wherein the gauge comprises indentations, the system further comprising a needle having a protruding detent that interfaces with the indentations to indicate the position of the valve element.

11. The conservation device of claim 10, wherein the gauge comprises markings on the body between the first pivot stop and the second pivot stop in the same locations as the indentions, the system further comprising a mark on the axle that interfaces with the markings on the body to indicate the position of the valve element.

12. The conservation device of claim 1, wherein the lever is tapered to create a pointer on the distal end portion.

13. The conservation device of claim 12, wherein the pointer interfaces with the markings on the body to indicate the position of the valve element.

14. The conservation device of claim 9, wherein the gauge comprises indicia identifying an amount that the valve element is open or closed.

15. The conservation device of claim 1, wherein the valve element is a ball valve.

16. The conservation device of claim 1, wherein the pivot axle is integral with the valve element.

17. The conservation device of claim 1, wherein the lever has a first length and the handle has a second length, the second length being greater than the first length.

18. The conservation device of claim 17, wherein the handle has a length within the range of 12 and 24 inches.

19. A water, sewer, and gas or electric conservation system, comprising:
a body portion including an inlet, an inner surface, an outer surface, the inlet being configured to mate with a separate plumbing fixture, and a reduced flow outlet;
a valve element disposed within the body portion, the valve element including a port and being pivotable within the body portion between an open position and a closed position, the open position providing fluid communication through the body portion and the closed position restricting fluid communication through the body portion;
a pivot axle integrally connected to the valve element and extending from the inner surface of the body to the outer surface;
a lever having a first distal end portion and a first proximal end portion, the lever being rigidly connected to and extending from the axle;
a pivot stop configured to limit the range of rotation of the pivot axle, the range of rotation being limited to about 90 degrees or less; and
a rigid handle having second distal end portion and a second proximal end portion, the second distal end portion of the handle being pivotably connected to the first proximal end portion of the lever by a connector, the connector permitting the handle to freely pivot relative to the lever so that the handle freely hangs vertically downward from the connector.

20. The conservation system of claim 19, wherein the second proximal end portion is formed to be handicap accessible for actuation with a nub of a limb.

21. The conservation system of claim 19, wherein the valve element is a ball valve.

22. The conservation system of claim 19, further comprising a shower nozzle adjacent the body portion.

23. The conservation system of claim 19, wherein the lever has a first length and the handle has a second length, the second length being greater than the first length.

24. The conservation system of claim 23, wherein the handle has a length within the range of 12 and 24 inches.

25. A water, sewer, and gas or electric conservation system, comprising:
a body portion including an inlet, a reduced flow outlet, an inner surface, and an outer surface, the inlet being configured to mate with a separate plumbing fixture;
a ball valve element disposed within the body portion, the valve element including a port and being pivotable within the body portion between an open position and a closed position, the open position providing fluid communication through the body portion and the closed position restricting fluid communication through the body portion;
a pivot axle connected to the valve element and extending from the inner surface of the body to the outer surface;
a lever having a first distal end portion and a first proximal end portion, the lever being rigidly connected to and extending from the axle;
a pivot stop located on the body portion to limit a range of rotation of the pivot axle by mechanically blocking movement of the lever beyond the range of rotation, the range of rotation being limited to about 90 degrees or less; and
a rigid handle having a second distal end portion and a second proximal end portion, the second distal end portion of the handle being pivotably connected to the first proximal end portion of the lever by a connector, the connector permitting the handle to freely pivot relative to the lever so that the handle freely hangs vertically downward from the connector, the handle having total length within the range of about 12 and 36 inches for operating by a user.

26. The conservation device of claim 9, wherein the system further comprises a mark on the axle that cooperates with the markings on the body to display the position of the valve element.
